(19) United States
(12) Patent Application Publication
(10) Pub. No.: US 2006/0221083 A1
(43) Pub. Date: Oct. 5, 2006

(54) Method for displaying an image assigned to a communication user at a communication terminal

(75) Inventors: Jesus Fernando Guitarte Perez, Munchen (DE); Carlos Lucas, Zaragoza (ES); Klaus Lukas, Munchen (DE)

Correspondence Address: LERNER GREENBERG STEMER LLP, P O BOX 2480, HOLLYWOOD, FL, 33022-2480, US

(73) Assignee: Siemens AG

(21) Appl. No.: 11/396,021

(22) Filed: Mar. 31, 2006

(30) Foreign Application Priority Data
Mar. 31, 2005 (DE) 10 2005 014 772.0

(51) Int. Cl. G06T 15/70

(52) U.S. Cl. 345/473

(57) ABSTRACT

A technical function that is of interest for mobile or stationary communication terminals is the playing of a video of the corresponding person when a call is received. However, the playing of a video during an incoming call is associated with highly complex processes, as the stored videos have to be decoded in real time. The object of the present invention is therefore to specify a method, which reduces the required computing power and storage capacity. The object is achieved by a method in which an image of the calling person is animated by a face animation algorithm.

### BACKGROUND OF THE INVENTION

### Field of the Invention

The present invention relates to a method and a computer program product for displaying an image assigned to a communication user at a communication terminal.

One technical function that is of interest for mobile or stationary communication terminals is the displaying of an image, in particular a portrait, of the caller on a control and display unit of the communication terminal when an incoming call is received. The name and telephone number of the caller are generally also displayed along with an image of the caller. These so-called “calling faces” extend the multimedia character of communication terminals in a particularly user-friendly manner, as they allow a user to identify immediately who is calling. This function also allows further personalization of communication terminals, which is seen as a key factor for success in the communication sector.

A further technical function of interest for mobile or stationary communication terminals is the playing of a video of the relevant person when an incoming call is received. These so-called “ringing videos” are used increasingly in communication terminals.

One disadvantage of the “ringing videos” method is that playing videos during an incoming call is associated with highly complex processes, as the stored videos have to be decoded in real time. It is therefore not possible to use this function on many communication terminals, which have inadequate computing power and storage capacity. Also a personalized video must be assigned if possible to every person in the communication user list (address book) of a user. This requires a significant amount of storage capacity, as the individual videos all have to be stored on the communication terminal. For example a single video 10 seconds long with a bit stream rate of 128 kbit per second requires approximately 1 Mbit or 160 kbyte of storage space. Therefore a good 1 Mbyte storage space would be required for a hundred entries each with an assigned video. This results in that there is only storage space available for one video on most communication terminals.

### SUMMARY OF THE INVENTION

It is accordingly an object of the invention to provide a method for displaying an image assigned to a communication user at a communication terminal which overcomes the above-mentioned disadvantages of the prior art methods of this general type, which reduces the required computing power and storage capacity.

With the foregoing and other objects in view there is provided, in accordance with the invention, a method for displaying an image assigned to a communication user at a communication terminal. In the method, the image is assigned to at least one list entry of a communication user list. A face location algorithm is used to determine image coordinates of facial features in the image. The image coordinates of the facial features are assigned to the respective image. The image assigned to the list entry can be retrieved by a control character. The retrieved image is animated with the aid of the assigned image coordinates of the facial features on receipt of the control character. The animated image is displayed on a display device of the communication terminal. The computing power required is hereby advantageously reduced, as the decoding of a JPEG image for example followed by animation requires significantly less computing than the decoding of an MPEG video. Less storage capacity is also required to a differing degree to store a JPEG image and the associated parameters for animation than to store an MPEG video. The method can thus be used even on communication terminals with a low level of computing power and storage capacity.

Face location methods have similar functions to image analysis methods. Without limiting the general nature of the term, image analysis methods are for example methods for pattern recognition or for detecting objects in an image. With these methods, a first step generally involves segmentation, whereby pixels are assigned to an object. In a second step morphological methods are used to identify the shape and/or form of the objects. Finally in a third step the identified objects are assigned to specific classes for classification purposes. A further typical example of an image analysis method is for example handwriting recognition.

A face animation algorithm controls the movement of characteristic facial feature points, for example predefinable points on the mouth, chin or eyes, using predefinable face animation parameters. Face animation parameter units are defined in order to be able to animate faces of different sizes or proportions with a comparable result. These are standardized using the spatial distances between the main facial features (e.g. mouth, nose, eyes) of a specific face.

The pixels in the vicinity of the displaced facial feature points are for example determined using standard interpolation methods.

According to a preferred embodiment of the present invention the control character is triggered by a call from a communication user. This allows the called user to identify immediately who is calling.

According to a further advantageous embodiment of the present invention image animation is synchronized with an acoustic signal of the communication terminal. For example the animated movement of a mouth or eyebrows can be synchronized with a ringtone.

According to a further advantageous embodiment of the present invention, image animation is synchronized with a haptic signal of the communication terminal. The animated movement of the head can thus be synchronized for example with a vibration alarm.

During operation of the computer program product the program scheduler assigns the image to at least one list entry in a communication user list in order to display an image assigned to a communication user at a communication terminal. A face location algorithm is used to determine image coordinates of facial features in the image. The image coordinates of the facial features are assigned to the respective image. The image assigned to a list entry can be retrieved by use of a control character. The retrieved image is animated with the aid of the assigned image coordinates of the facial features on receipt of the control character. The animated image is displayed on a display device of the communication terminal.

Other features which are considered as characteristic for the invention are set forth in the appended claims.

Although the invention is illustrated and described herein as embodied in a method for displaying an image assigned to a communication user at a communication terminal, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic illustration of a model face with a neutral facial expression and facial features to locate a face in an image according to the invention; and

FIG. 2 is diagrammatic illustration of a model face with a neutral facial expression and facial feature points to define a facial expression.

### DESCRIPTION OF THE PREFERRED EMBODIMENTS

According to an exemplary embodiment of the present invention a user assigns a stored image of a person XY to a corresponding address book entry for person XY on their mobile communication terminal. A face location algorithm is used to locate the face in the image and to identify the image coordinates of eyebrows, eyes, nose and mouth and store them as features assigned to the respective image on the mobile communication terminal.

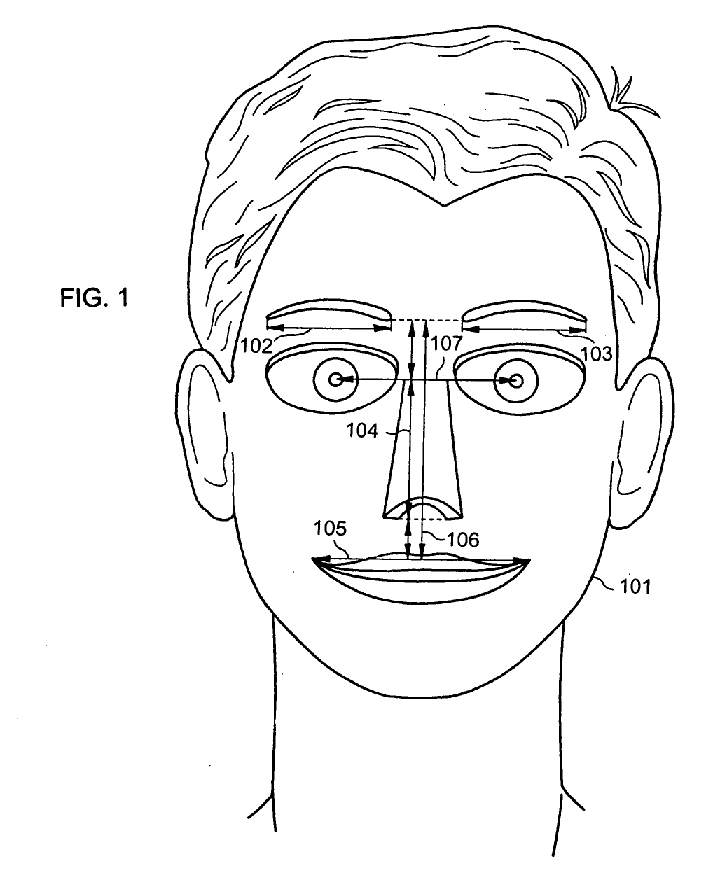

Referring now to the figures of the drawing in detail and first, particularly, to FIG. 1 thereof, there is shown a neutral face 101, in which individual facial features 102 to 107 have been determined by a face location algorithm.

A geometric method for analyzing an image to determine the presence and position of a face first defines segments having brightness-specific features in the recorded image. The brightness-specific features may for example include light/dark transitions and/or dark/light transitions. The positional relationship of the defined segments to each other is then checked, with the presence of a (human) face, in particular at a specific position in the recorded image, being inferred, if a selection of defined segments has a specific positional relationship. Therefore the method described here can be used to conclude the presence of a face, in particular a human face, by analyzing specific areas of the recorded image, namely the segments with brightness-specific features, more precisely by checking the positional relationship of the defined segments.

In particular segments are defined in the recorded image, in which the brightness-specific features show sharp or abrupt brightness transitions, for example from dark to light or light to dark. Such (sharp) brightness transitions are found for example in a human face, in particular in the transition from forehead to eyebrows 102 and 103 or (in the case of people with light hair color) in the transition from forehead to the shadow of the eye sockets 107. Such (sharp) brightness transitions are however also found in the transition from the upper lip area or lip area to the mouth opening or from the mouth opening to the lip area of the lower lip or to the lower lip area 105. A further brightness transition occurs between the lower lip and the chin area, more precisely as an area of shadow (depending on light conditions or light incidence) due to a slight arching of the lower lip. By preprocessing the image using a gradient filter it is possible in particular to highlight and show up (sharp) brightness transitions like those at the eyebrows 102 and 103, the eyes 107 or the mouth 105.

To check the positional relationship of the defined segments in a first investigative step for example each of the defined segments is examined to determine whether a second defined segment exists for a segment to be examined on a horizontal line or a substantially horizontal line in relation to the defined segment being examined. Based on a recorded image containing a number of pixels, the second segment does not necessarily have to be on one of the horizontal lines of pixels included in the segment to be examined, it can also be a predefined small number of pixels higher or lower than the horizontal line 102 or 103. If a second defined horizontal segment 103 or 102 is found, a third defined segment is searched for below the examined segment and the second defined segment, for which a first predefined relationship exists between the distance from the examined segment to the second defined segment and the distance from a connecting line between the examined segment and the second defined segment to the third defined segment. In particular a line 106 perpendicular to the connecting line between the examined segment and the second defined segment can be defined, with the distance from the third segment (along the perpendicular line) to the connecting line between the examined segment and the second defined segment being part of the first predefined relationship. The first investigative step described above allows the presence of a face to be concluded by determining the positional relationship between three defined segments. It is assumed here that the examined segment and the second defined segment represent a respective eyebrow section in the human face, which generally has a marked or sharp light/dark transition in a downward direction and can therefore be easily identified. The third defined segment represents a segment of a mouth section or the boundary area 105 forming a shadow between the upper lip and lower lip. As well as being able to use eyebrows as marked segments with brightness-specific features, it is also possible to use areas of the eye sockets that form shadows or the eyes or the iris 107 itself instead of the eyebrows. The method can be extended as required to additional segments to be examined, for example including identification of eyeglasses or additional verifying features (nose 106, open part of mouth 105).

After a face has been located in the image, the face location algorithm is used for example to segment the individual facial features, in other words to assign pixels to an object, for example right eyebrow 102, left eyebrow 103 or mouth 105. Edge detection is used to determine the pattern of the edge of the individual facial features and the face location algorithm is then used to determine characteristic facial feature points along the detected edge pattern at predefinable points of the respective facial feature.

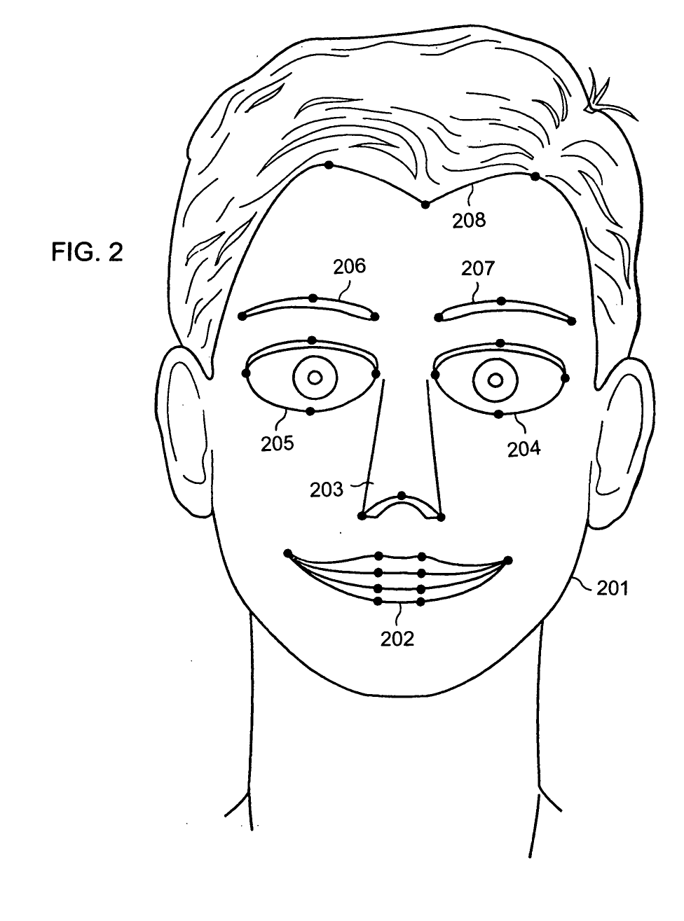

FIG. 2 shows a face with a neutral facial expression 201, in which such characteristic facial feature points have been determined. Facial feature points can thus be identified on a mouth 202, a nose 203, eyes 204 and 205, eyebrows 206 and 207, and hairline 208.

When the person XY calls the mobile communication terminal of the user, in this exemplary embodiment a control character is triggered, retrieving the image assigned to the address book entry of the person XY with the associated image coordinates of the facial feature points. The image is animated using a face animation algorithm based on the facial feature points and the animated image is displayed on a display device of the mobile communication terminal.

With a face animation algorithm the movement of characteristic facial feature points is for example controlled using predefinable face animation parameters. These face animation parameters for example indicate the amplitude by which the right mouth angle in 202 must be moved for a small smile. A number of face animation parameters can therefore be used to generate a complete facial expression with different intensities from sad through surprised or annoyed to happy. Face animation parameter units are defined in order to be able to animate faces of different sizes or proportions with a comparable result. These are standardized using the spatial distances between the main facial features of a specific face. The pixels in the vicinity of the displaced facial feature points are for example determined using standard interpolation methods.

According to a further exemplary embodiment of the present invention, animation is synchronized with a ringtone of the mobile communication terminal. Image animation can hereby be synchronized using time markers in the acoustic signal, which for example map a period interval of the acoustic signal. Visemes can also be used for the purposes of synchronization in particular with an acoustic voice signal. These are the visual equivalents of phonemes (sound modules) and show the typical position and/or movement in particular of the mouth during specific characteristic phonemes, such as (/p/, /b/, /m/), /U/ or /A:/. If the phonemes of the acoustic voice signal are known, they can also be used to control face animation using the assigned visemes.

Use of the present invention is not restricted to the exemplary embodiments described here.

This application claims the priority, under 35 U.S.C. § 119, of German patent application No. 10 2005 014 772.0, filed Mar. 31, 2005; the entire disclosure of the prior application is herewith incorporated by reference.

We claim:

1. A method for displaying an image assigned to a communication user on a communication terminal, which comprises the steps of:
assigning the image to at least one list entry in a communication user list;
using a face location algorithm for determining image coordinates of facial features in the image;
assigning the image coordinates of the facial features to the image resulting in assigned image coordinates;
retrieving the image assigned to the list entry by use of a control character;
animating a retrieved image with an aid of the assigned image coordinates of the facial features by performance of a face animation algorithm on receipt of the control character; and
displaying an animated image on a display device of the communication terminal.

2. The method according to claim 1, which further comprises triggering the control character upon receiving a call from the communication user.

3. The method according to claim 1, which further comprises triggering the control character upon receiving an incoming text and/or voice message from the communication user.

4. The method according to claim 1, which further comprises triggering the control character by selection of the list entry from the communication user list.

5. The method according to claim 1, which further comprises controlling the face animation algorithm by the communication user using predefinable parameters.

6. The method according to claim 1, which further comprises predefining the facial features to be determined by action of the communication user.

7. The method according to claim 1, which further comprises synchronizing image animation with an acoustic signal of the communication terminal.

8. The method according to claim 1, which further comprises synchronizing image animation with a haptic signal of the communication terminal.

9. A computer-readable medium having computer-executable instructions for loading into a main memory of a program scheduler and for performing a method comprising:
assigning an image to at least one list entry of a communication user list;
performing a face location algorithm for determining image coordinates of facial features in the image;
assigning the image coordinates of the facial features to the image;
retreiving the image assigned to the list entry by use of a control character;
animating a retrieved image with an aid of the image coordinates of the facial features by use of a face animation algorithm on receipt of the control character; and
displaying an animated image on a display device of the communication terminal, when the computer-executable instructions operate in the program scheduler.
